(19) United States
(12) Patent Application Publication
(10) Pub. No.: US 2016/0197510 A1
(43) Pub. Date: Jul. 7, 2016

(54) Wireless near field communication device and power transmitter and a method for wirelessly transmitting operating power to another device

(71) Applicant: Teknologain tutkimuskeskus VTT Oy, Espoo (FI)

(72) Inventors: Esko Strömmer, Espoo (FI); Marko Jurvansuu, Espoo (FI)

(21) Appl. No.: 14/912,096

(22) PCT Filed: Aug. 15, 2014
(86) PCT No.: PCT/FI2014/050627

§ 371 Date: Feb. 15, 2016

(30) Foreign Application Priority Data
Aug. 15, 2013 (FI) 20135834

(51) Int. Cl. H02J 7/02; H04B 5/00; H04W 4/00

(52) U.S. Cl. CPC H02J 7/025; H04W 4/008; H04B 5/0037; H04B 5/0031; H02J 2007/0096

(57) ABSTRACT

The invention relates to a combined near field communication and wireless power transmitter device comprising a first antenna coupled to antenna tuning network and capable of coupling to one or more second antennae in the near field of the first antenna with coupling characteristics, means for communicating wirelessly using said first antenna with a near field communication device in a near field communication mode, and means for transmitting wirelessly power using said first antenna to another device in the vicinity of the first antenna in a power transmission mode. In power transmission mode, the antenna tuning network operates in resonance and has an initial input impedance which is configured to change if there is a change in the coupling characteristics during power transmission, for example charging. The invention also relates to a method of transmitting power to a mobile device for example for charging purposes.

### FIELD OF THE INVENTION

The invention relates to wireless powering of devices. In particular, the invention relates to a novel wireless power transmitter with near field communications capabilities and a method of transmitting power to another device. The power transmitter and the method can be used for example for charging an electric device, such as a mobile device.

### BACKGROUND OF THE INVENTION

Wireless operating power transmission, e.g. wireless charging, has become possible through recent power transmission technologies for mobile devices, such as mobile phones and tablets. The topic has also more popular as the number of mobile devices has increased rapidly and there are various commercial solutions available. At the same time, manufacturers are incorporating near field communication (NFC) technology into mobile devices. There are also some devices, which may have both the wireless charging and NFC capabilities. Some of these are briefly introduced below.

US 2012/0267960 discloses a receiver suitable for wireless power reception. The receiver may comprise a detection circuit and a tuning circuit, which can be used to tune the receiver. The receiver may also comprise NFC functionality.

WO 2012/014634 discloses a wireless charging transmitter including a parasitic resonant tank, being kind of an auxiliary antenna tuned into resonance. The document also discloses a solution comprising a separate passive stabilizing resonator for compensating effects caused by coupling of the transmitter antenna to external devices.

WO 2010/060118 discloses retrofitting existing electronic devices for wireless power transfer and near-field communication. Retrofitting circuitry includes an antenna for receiving a signal from an external source, and conversion circuitry for converting the signal to be used by an electronic device. The antenna and conversion circuitry may be configured to receive and convert the signal to generate wireless power for the electronic device. The antenna and the conversion circuitry may also be configured to enable the electronic device to send and receive near-field communication data.

There are also specific transmission control integrated circuits for wireless charging systems utilizing an NFC antenna. One such IC is the Renesas R2A45801FT chip described in respective product sheet.

Wireless charging is further discussed in e.g. US 2010/0207572, US 2009/0284082, US 2011/0057606 and US 2012/0194124. Several prior art publications relate to NFC communication relating to charging or optimizing the transmitted power by inductive antenna designs. NXP has published an AN1445 antenna design guide for NFC devices, disclosing several antenna topologies for various NFC communication uses.

There are hardly any solutions disclosed for mitigating the undesired effects of rapid changes of the coupling of the wireless transmitter and a receiver tuned into resonance for efficient charging. Such effect may include damaging of electronic components of the transmitter due to exceeding of allowed voltage or current levels, and potential damaging of other nearby NFC devices or heating of metal objects in the vicinity the transmitter antenna due to rapidly increased field emissions.

### SUMMARY OF THE INVENTION

It is an aim of the invention to solve at least some of the abovementioned problems and to provide an improved wireless power transmitter device with near field communication and wireless power transmitting capability.

A particular aim is to provide an efficient, electrically protected and safe-to-use NFC-compatible wireless charger device.

A further aim is to provide a novel method for charging a mobile device wirelessly with an NFC-compatible power transmitter.

Another further aim is to enhance the power transmission capability of NFC devices for powering advanced transponder type devices such as NFC-compatible sensors.

The invention is based on providing a combined near field communication and wireless power transmitter device, comprising a first antenna (also called transmitter antenna) coupled to an antenna tuning network, means for communicating wirelessly using said first antenna with a near field communication device, and means for transmitting wirelessly using said first antenna power to a battery-operated mobile device for charging the battery of the mobile device. According to the invention, the device changes electrical properties of the antenna tuning network of the first antenna based on changes in the coupling characteristics but still maintains the resonance of the antenna tuning network. In particular, the properties of the antenna tuning network to be changed comprise the input impedance of the antenna tuning network in response to electromagnetic changes in proximity state or power absorbing capability of other devices in near field of the present device, most notably the device currently to be charged.

The term “change in coupling characteristics” covers in particular changes in the coupling coefficient between the first and second antenna(e) and changes in effective load resistance of the second antenna(e) (also called receiver antenna(e)). These changes may take place e.g. due to changes in the relative location or orientation of the first and second antennae, or changes in the properties of the second antenna or the device to be charged.

The term “input impedance” (in particular of the transmitter antenna tuning network, Z_{IN}′), if not otherwise mentioned, means the magnitude of the complex input impedance (|Z_{IN}′|). The term “resonance”, if not otherwise mentioned, means that the imaginary part of Z_{IN}′ is negligible, i.e., essentially equal to 0.

In a preferred embodiment of the invention the input impedance of the antenna tuning network is adapted to be decreased if a second antenna is detected to be brought closer to the first antenna or the effective load resistance of the second antenna decreases, and to be increased if a second antenna is detected to be moved away in or from the near field of the first antenna or the effective load resistance of the second antenna increases. Simultaneously to adapting its input impedance, the antenna tuning network is adapted to keep the first antenna circuit in resonance regardless of the changes in the coupling characteristics. The adaptation is preferably passive and self-adjusting, meaning that no active monitoring and control logic and/or load sensing circuits are required. A detailed implementation on this kind is described in detail later in this document.

More specifically, the invention is characterized by what is stated in the independent claims.

The invention has considerable advantages. First, an NFC device based on the invention can transmit high power levels to a nearby power receiver with resonance tuned antenna circuit with relatively low AC voltage level at the input of the antenna tuning network, since the vicinity of the receiver antenna decreases the input impedance of the antenna tuning network. Thus, the RF generator feeding AC power into the antenna tuning network during power transmission can operate with relatively low supply voltage. Moreover, the antenna tuning network will keep its resonance with the vicinity of the receiver antenna, which cancels the idle power from the RF generator and thus decreases power loss in the RF generator.

Second, if the effective load resistance connected to the power receiver antenna increases or decreases, the input impedance of the antenna tuning network increases or decreases respectively, which stabilizes the voltage level at the power receiver output and at the power transmitter antenna tuning network input when the power taken by the receiver changes. This also reduces the variability of the required supply voltage of the RF generator.

Third, if the relative location or orientation of the transmitter antenna and the receiver antenna changes, the antenna tuning network will keep its resonance, which cancels the idle power from the RF generator and thus decreases power loss in the RF generator.

Fourth, if the power receiver is abruptly taken away from the vicinity of the power transmitter or if the power receiver cuts off the power absorption for some reason, the input impedance of the antenna tuning network increases, which reduces the input power to the antenna tuning network. The input power reduction prevents the antenna current and field emissions of the power transmitter from increasing remarkably in spite of the disappeared shielding effect created by the nearby power receiver, which increase could be harmful and hazardous to other nearby NFC and other devices such as RFID memory tags and contactless smart cards. The input power reduction also prevents the voltage levels of the antenna tuning network from rising remarkably.

The dependent claims are directed to selected embodiments of the invention.

According to one embodiment, there is provided a combined near field communication and wireless power transmitter device, comprising a first antenna coupled to antenna tuning network and capable of coupling to one or more second antennae in the near field of the first antenna with coupling characteristics, means for communicating wirelessly using said first antenna with a near field communication device in an NFC communication mode, and means for transmitting wirelessly power using said first antenna to a battery-operated mobile device in the vicinity of the first antenna for charging the battery of the mobile device in a power transmission mode. In power transmission mode, the antenna tuning network has an initial input impedance which is configured to change if there is a change in the coupling characteristics during charging. The coupling characteristics may include the coupling coefficient between the first antenna and the second antenna in the near field of the first antenna and/or the loading state of the second antenna, the second antenna typically belonging to the mobile device to be charged.

Generally speaking, there are provided means for exchanging between a NFC communication mode utilizing said means for communicating wirelessly with a near field communication device and a power transmission mode utilizing said means for transmitting power wirelessly to the mobile device. According to one embodiment, the modes are adapted to be in use one at a time. However, in one embodiment, there are also provided means for combined mode with simultaneous NFC communication and power transmission.

In one embodiment, the means for communicating wirelessly with a near field communication device comprise an NFC RF generator and an NFC tuning network for the NFC communication mode operation of the device, and the means for transmitting power comprise a power RF generator separate from the NFC RF generator for power transmission mode operation of the device. The device further comprises a switch for decoupling the power RF generator from the NFC RF generator at least in the power transmission mode. The switch, when in open state, preferably decouples the antenna tuning network from the NFC tuning network in the power transmission mode such that the NFC tuning network doesn't disturb the power transmission mode operation.

In another embodiment, the means for communicating wirelessly with a near field communication device comprise a common RF generator and tuning network for the NFC communication mode operation and the power transmission mode operation of the device.

According to one aspect, the invention concerns a respective method for transmitting power to an electronic device. The electronic device can be a mobile battery-operated device, whereby the power transmitted is used to charge the battery of the mobile battery operated device. In another embodiment, the electronic device is an NFC transponder, in particular an NFC transponder with an integrated sensor, and said power transmitted is used to excite, i.e., activate the transponder.

The present method of charging a mobile battery-operated device with a charging device capable of near field communication in an NFC communication mode and wireless charging of said mobile device in a power transmission mode through a single first antenna coupled to an antenna tuning network having an input impedance comprises using said charging device in an NFC communication mode and exchanging the charging device to a power transmission mode for charging the mobile device. The mobile device has a second antenna coupled with the first antenna with initial coupling characteristics and tuned into resonance at the same frequency with the first antenna. According to the invention the input impedance of the antenna tuning network is varied if the coupling characteristics of the first and second antenna change during said charging.

The terms near field communication and NFC as herein used refer to short-distance (communication distance typically less than 10 cm) radio-frequency data transfer techniques between two devices, in particular those techniques conforming to ISO/IEC 18092 and/or ISO/IEC 21481 and/or ISO/IEC 14443 standards in their present an upcoming versions and/or derivatives.

Next, embodiments, advantages and further uses of the invention are described in more detail with reference to the attached drawings.

### BRIEF DESCRIPTION OF THE DRAWINGS

FIG. 1 shows a combined NFC and power transmitter device and a mobile battery-operated device.

FIG. 2 shows a block diagram of the RF parts in the combined NFC and power transmitter device shown in FIG. 1 according to one embodiment of the invention.

FIG. 3 illustrates an implementation of the RF generator and the antenna tuning network elements shown in FIG. 2 according to one embodiment of the invention.

FIG. 4 illustrates another implementation of the RF generator and the antenna tuning network elements shown in FIG. 2 according to another embodiment of the invention.

FIG. 5 shows an equivalent circuit diagram of a resonance tuned power receiver in the mobile device shown in FIG. 1.

### DETAILED DESCRIPTION OF EMBODIMENTS

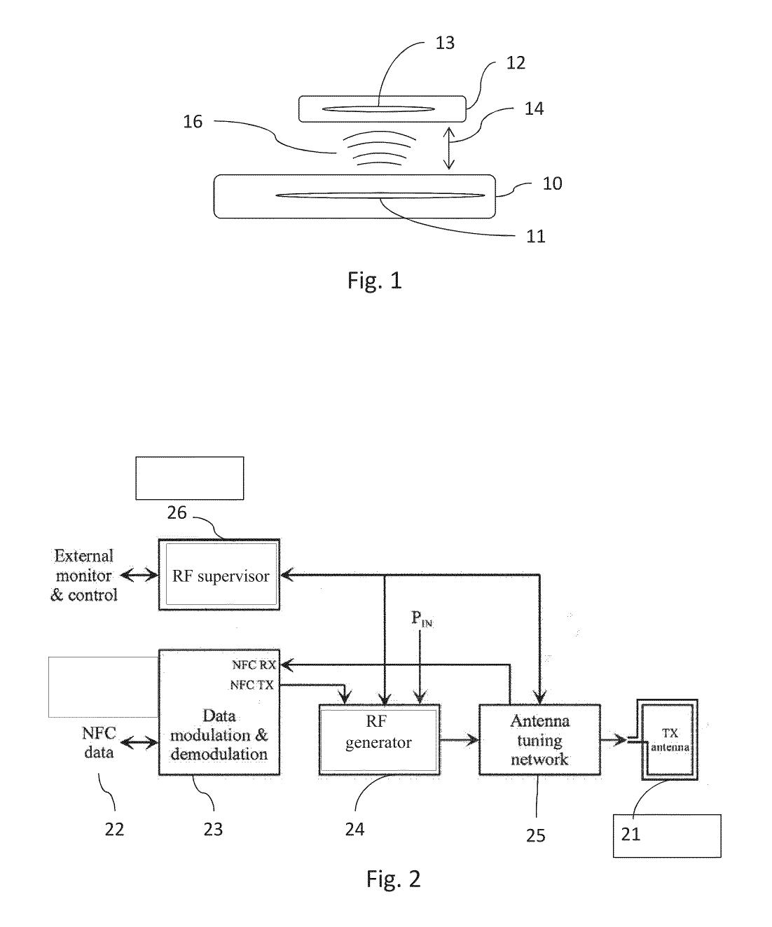

FIG. 1 shows a combined NFC and power transmitter device 10 comprising a TX antenna 11 for power transmission and bi-directional NFC communication. There is also shown a mobile device 12 comprising an RX antenna 13, being adapted to receive power and optionally also being adapted for NFC communication. The NFC link between these two devices is denoted with a reference numeral 14 and the power transmission link with a reference numeral 16.

The NFC and power transmitter device 10 can be driven in separate NFC communication mode and power transmission (charging) mode, i.e., such that during power transmission mode, the NFC communication is blocked and vice versa. There can also be a combined mode with simultaneous NFC communication and power transmission, in which NFC data modulation with higher RF power level than in NFC communication mode is applied.

The NFC and power transmitter device 10 may be, for example, a wireless charger device, base station or docket station of any desired type. The mobile device 12 may be a mobile telephone, tablet device, portable computer, wristop computer, data storage device and/or media player device, to mention some examples.

FIG. 2 illustrates one possible embodiment of the RF parts in the combined NFC and power transmitter device 10 as a block diagram. The TX antenna is denoted with a reference numeral 21. In this embodiment, there is provided an RF generator element 24 operating at 13.56 MHz frequency at least during NFC communication and preferably also during power transmission. In the NFC communication mode, the RF generator element 24 produces the carrier wave for NFC communication, optionally with associated TX data modulation. In the power transmission mode, the RF generator 24 provides the carrier wave for power transmission. Between the RF generator element 24 and the TX antenna 21, there is provided an antenna tuning network. The RF generator and the antenna tuning network are controlled and optionally also monitored by an RF supervisor 26 that is capable of monitoring and controlling, i.e., changing the behavior and/or electrical properties of both these elements 24, 25 for obtaining optimal operation in both modes.

The control functions can concern, for example, selecting between the NFC communication mode and the power transmission mode, and adjusting the power level of the RF generator. The monitoring functions can concern, for example, monitoring the input DC power level P_{IN} to the RF generator. The transmitted NFC data messages are provided to the RF generator 24 from and the received NFC data messages are guided from the TX antenna 21 to an NFC data modulation and demodulation unit 23, which processes the NFC data messages in both directions. At least for the power transmission mode, the RF generator 24 may comprise an additional power input P_{IN} for achieving a power level sufficient for wireless battery charging.

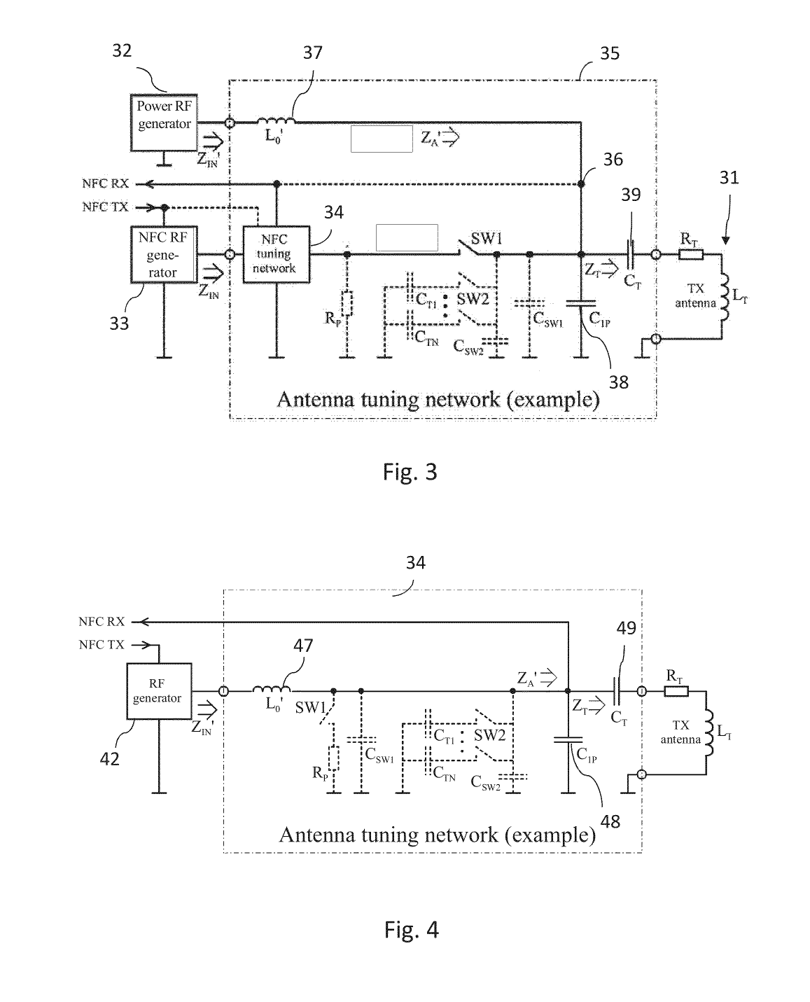

FIG. 3 illustrates a possible embodiment of the RF generator 24, the antenna tuning network 25 and the TX antenna 21 in FIG. 2. In this implementation, the RF generator 24 involves a power RF generator 32 operating in the power transmission mode and another NFC RF generator 33 operating in the NFC communication mode. Switch SW1 is used to select the mode of operation of the device. SW1 being closed, the NFC RF generator 33 and the NFC tuning network 34 are connected to the TX antenna 31, and SW1 being open, the power RF generator 32 feeds the TX antenna 31 via an inductor 37. The equivalent circuit of the TX antenna 31 involves an equivalent inductance L_{T} and an equivalent series resistance R_{T}. Optionally, there is a resistor R_{P} for reducing the quality factor of the antenna circuit in the NFC communication mode, which is often needed to meet the transient time requirements of the modulated carrier signal in the NFC specifications.

In one embodiment, there is also another switch (not shown) in the power RF feed line (e.g. between tuning inductance L₀′ and the contact point 36 of the power RF generator and NFC RF generator feed circuits) to disconnect the power RF generator 32 from the antenna 31 during NFC communication mode and connecting the power RF generator 32 to the antenna 31 again during power transfer mode.

According to one embodiment, the antenna tuning network is adapted to keep the TX antenna circuit in resonance in the power transmission mode with the presence of a power receiver tuned into resonance regardless of the coupling coefficient between the TX antenna and the RX antenna and the effective load resistance in the power receiver. This can be implemented by the configuration of FIG. 3 in which the NFC RF generator and the NFC tuning network are connected to the TX antenna via a connection point and the same connection point is connected to the power RF generator, the power RF generator forming part of the means for transmitting power wirelessly to another device. There is provided a series tuning inductance (L₀′, 37) component between the connection point and the power RF generator, a series tuning capacitance (C_{T}, 39) component between the connection point and the first antenna and a parallel tuning capacitance (C_{1P}, 38) component between the connection point and ground. By suitably selecting the values of these components, the circuit is tuned so that its input impedance Z_{IN} changes as desired and the transmitter antenna tuning network stays in resonance irrespective the equivalent series resistance R_{T} of the antenna. Thus, the antenna does not cause idle power load for the power RF generator. The described solution includes only few additional tuning components and is therefore robust and inexpensive to implement.

The embodiments described above represent so-called single-ended implementations. According to an alternative embodiment, the essential parts of the device, most notably the RF generator and the antenna, are duplicated into two parallel portions, which are arranged to operate in opposite phases with respect to each other. Such differential implementations of RF devices are known per se but may provide additional advantages in the present combined device context in some applications.

It should be noted that in the configuration shown in FIG. 3, the capacitor C_{T} alone does not form a resonance circuit with the TX antenna unlike in some prior art solutions for tuning an antenna. In addition, the values of L₀′ ja C_{1P} are chosen not arbitrarily but carefully to match the other components and notably C_{T}.

L₀′ ja C_{1P} (as well as L_{T} and C_{T}) form an EMC filter which filters out harmonic components originating from the power RF generator.

The solution advantages described above are valid even without switch SW2 and the other additional related components shown. However, in one embodiment, switch SW2 and related circuit is present. This has the advantage that potential detuning of the receiver and/or component tolerances can be compensated by the capacitances C_{T1} . . . C_{TN}. Therefore, the efficiency of the power transmitter is at highest.

FIG. 4 illustrates another possible embodiment of the RF generator 24, the antenna tuning network 25 and the TX antenna 21. There is one RF generator 42 operating both in the NFC communication mode and in the power transmission mode. There is provided a series tuning inductance (L₀′, 47) component, a series tuning capacitance (C_{T}, 49) component, and a parallel tuning capacitance (C_{1P}, 48) component. By suitably selecting the values of these components, the circuit is tuned so that its input impedance Z_{IN}′ changes as desired and the antenna tuning network stays in resonance irrespective the equivalent series resistance R_{T} of the antenna. Thus, the antenna does not cause idle power load for the RF generator. Optionally, there is a resistor R_{P} connected by a switch SW1 for reducing the quality factor of the antenna circuit in the NFC communication mode, which is often needed to meet the transient times of the modulated carrier signal within the NFC specifications. An optional switch SW2 and related circuit has the advantage that potential detuning of the receiver and/or component tolerances can be compensated by the capacitances C_{T1} . . . C_{TN}. Therefore, the efficiency of the power transmitter is at highest.

The device according to FIG. 4 can also be modified into a differential implementation similarly to the device according to FIG. 3 as described above.

Because of the common RF generator for both the NFC communication mode and power transmission mode, the implementation according to FIG. 4 can also operate in combined mode with simultaneous NFC communication and power transmission.

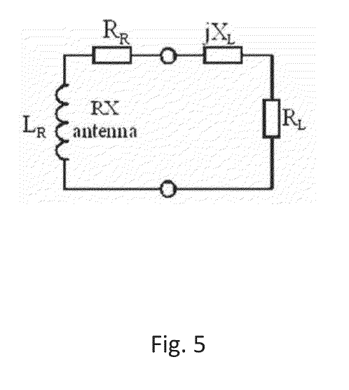

FIG. 5 illustrates an equivalent circuit diagram of a resonance tuned power receiver in the mobile device 12 in FIG. 1, which is usable in connection with the NFC and power transmitter device 10 according to the invention. L_{R} and R_{R} are the inductance of the antenna and loss-causing series resistance, respectively. X_{L} is the (capacitive) tuning reactance and R_{L} a load resistance exploiting the received power. The resonance of the receiver requires that the negative of the tuning reactance equals to the antenna reactance, i.e. ωL_{R}+X_{L}=0, where ω is the angular frequency used.

An inductive coupling between a resonance tuned power receiver according to FIG. 5 and an NFC and power transmitter device according to the invention causes the equivalent series resistance of the TX antenna (R_{T}) to significantly increase but the equivalent inductance of the TX antenna (L_{T}) remains the same, whereby the TX antenna circuit remains in resonance, which keeps the efficiency of the power transmission at high level.

The tuning of the circuit to function according to the principle of the invention is explained below in detail to illustrate how the invention can be carried out in practice.

Detailed Description of the Tuning of the Antenna in the Power Transmission Mode

Assumptions and Notations

FIG. 3 illustrates the connection topology of the transmitter antenna tuning network according to one embodiment. In this description, it is assumed that the optional parts of the circuit, shown in dashed lines at the branch of switch SW2 are not present in the circuit.

In the power transmission mode, switch SW1 is open.

The angular frequency of operation is set to ω=2π·13.56 MHz, corresponding to the basic frequency of NFC. The power fed from the power RF generator to the antenna tuning network of the transmitter is denoted with P_{IN}_{_}_{MATCH}′, which is selected for defining the transmitter antenna tuning network component values. The effective output voltage of the power RF generator is U_{IN}′. The inductance of the transmitter antenna 31 is L_{T} and the stray capacitance of the NFC switch SW1 is C_{SW1}.

The equivalent circuit of the power receiver part, shown in FIG. 5, is tuned into resonance, i.e., X_{L}=−ωL_{R} (X_{L} is negative, being realized with a capacitance). The other antenna parameters of the receiver antenna are L_{R} (inductance) and R_{R} (resistance). The antenna is coupled to a load with load resistance R_{L} having a matching value of R_{L}_{_}_{MATCH}, which is selected for defining the transmitter antenna tuning network component values.

The matching value of the coupling coefficient k between the transmitter and receiver antennae is k_{MATCH}, which is selected for defining the transmitter antenna tuning network component values.

The series impedance reflected from the receiver to the transmitter (change in R_{T}+jωL_{T} caused by the receiver) is denoted with Z_{TR}=R_{TR}+jX_{TR}. The matching value of this is real (i.e. X_{TR}_{_}_{MATCH}=0) and is denoted with R_{TR}_{_}_{MATCH}, which is selected for defining the transmitter antenna tuning network component values.

Procedure for Calculation of Tuning Components (C_{T}, C_{1P}, L₀′)

The values of tuning components are calculated using formulae (4)-(6) using matching values of the power fed to the antenna tuning network (P_{IN}_{_}_{MATCH}′), load resistance of the reference receiver (R_{L}_{_}_{MATCH}), and coupling coefficient (k_{MATCH}). The calculation utilizes intermediate values obtained using formulae (1) and (3) for R_{IN}_{_}_{MATCH}′ ja R_{TR}_{_}_{MATCH}.

The matching value of the input impedance of the antenna tuning network of the transmitter (known per se):

$${R}_{IN \_ MATCH}^{′} = \frac{{u}_{{IN}^{′}}^{2}}{{p}_{{IN \_ MATCH}^{′}}} \qquad ( 1 )$$

When the receiver is in resonance (X_{L}=−ωL_{R}), the series impedance reflected from the receiver to the transmitter (change in R_{T} caused by the receiver):

$${Z}_{TR} = {R}_{TR} + {jX}_{TR} = \frac{{k}^{2} {ω}^{2} {L}_{T} {L}_{R}}{{R}_{R} + {R}_{L}} + j 0 \qquad ( 2 )$$

Thus, Z_{TR} has a real value when the receiver is in resonance. Also this formula is generally known from public sources, such as http://www.wirelesspowerconsortium.com/technology/reflected-impedance.html, with slightly different symbol notation and using mutual inductance M=k\sqrt{L_{P}L_{S}} instead of coupling coefficient and ωC_{S}=−1/X_{L} instead of X_{L}.

Using the matching value of the series impedance reflected from the receiver to the transmitter, i.e., putting k_{MATCH} ja R_{L}_{_}_{MATCH} into formula (2) yields

$${R}_{TR\_MATCH} = \frac{{k}_{MATCH}^{2} {ω}^{2} {L}_{T} {L}_{R}}{{R}_{R} + {R}_{L\_MATCH}} \qquad ( 3 )$$

Then, the tuning capacitor C_{T} is given the value

$${C}_{T} = \frac{1}{{ω}^{2} {L}_{T} - ω \sqrt{{R}_{{IN\_MATCH}^{′}} ( {R}_{T} + {R}_{TR\_MATCH} )}} \qquad ( 4 )$$

The tuning capacitor C_{1P} is given the value

$${C}_{1 P} = \frac{1}{ω \sqrt{{R}_{{IN\_MATCH}^{′}} ( {R}_{T} + {R}_{TR\_MATCH} )}} - {C}_{SW 1} \qquad ( 5 )$$

And finally, the value of the tuning inductor L₀′ is

$${L}_{0}^{′} = \frac{\sqrt{{R}_{{IN\_MATCH}^{′}} ( {R}_{T} + {R}_{TR\_MATCH} )}}{ω} \qquad ( 6 )$$

Input Impedance of the Antenna Tuning Network

Using the tuning component values in the abovementioned formulae, the impedance levels of the antenna tuning network, using the notation and at the locations shown in FIG. 3, are

$$\begin{matrix}{Z}_{T} = {R}_{T} + {R}_{TR} + j ( ω {L}_{T} - \frac{1}{ω {C}_{T}} ) = {R}_{T} + {R}_{TR} + j \sqrt{{R}_{IN\_MATCH}^{′} ( {R}_{T} + {R}_{TR\_MATCH} )} & ( 7 ) \\ {Z}_{A}^{′} = … = \frac{{R}_{{IN\_MATCH}^{′}} ( {R}_{T} + {R}_{TR\_MATCH} )}{{R}_{T} + {R}_{TR}} - j \sqrt{{R}_{IN\_MATCH}^{′} ( {R}_{T} + {R}_{TR\_MATCH} )} & ( 8 ) \\ {Z}_{IN}^{′} = {Z}_{A}^{′} + jω {L}_{0}^{′} = \frac{{R}_{{IN\_MATCH}^{′}} ( {R}_{T} + {R}_{TR\_MATCH} )}{{R}_{T} + {R}_{TR}} & ( 9 )\end{matrix}$$

From the last formula (9), on can see that
Z_{IN}′ is real, i.e. the transmitter antenna tuning network does not intake idle power irrespective of the value of R_{TR} and further the values of k and R_{L}.
When k increases (i.e. the receiver is taking closer to the transmitter), according to formula (2) also R_{TR} increases, and therefore Z_{IN}′ decreases. Similarly, then k decreases (the receiver is taken farther from the transmitter), R_{TR} decreases and Z_{IN}′ increases.
When R_{L} decreases (the receiver takes more power), according to formula (2) R_{TR} increases, and therefore Z_{IN}′ decreases. Correspondingly, when R_{L} increases (the receiver takes less power), R_{TR} decreases and Z_{IN}′ increases.

Thus, by the described embodiment, the desired advantages of the invention are indeed achieved.

Similar contemplation as described above for FIG. 3 is also valid to the transmitter antenna tuning network in FIG. 4. As in the case of FIG. 3, SW1 is open in the power transmission mode.

Comparison of the System with Regard to Certain Pieces of Prior Art

NXP-AN1445 discloses three alternative antenna tuning network topologies: Antenna Topology I in FIG. 1, Antenna Topology II in FIG. 16 and Antenna Topology III in FIG. 24, the last one being closest with the present invention because it lacks C₂ present in the other topologies. Therefore, the following inspection is done in relation to Antenna Topology III (representing a differential implementation).

First, unlike prior art, the present solution according to FIG. 3 includes an NFC RF generator and a power RF generator allowing for the present device to act as a power transmitter. Herein, the NFC-circuit (NFC RF generator and NFC tuning network) are separated from the power RF generator by using a separate switch (SW1). This prevents the NFC circuit from loading the antenna tuning network and detuning it when the transmitter is in power transmission mode.

Second, concerning the present solution according to FIG. 3 and FIG. 4, from the viewpoint of the power RF generator, the TX antenna tuning network remains in resonance irrespective of the level of coupling of the power receiver and capability to receive power, i.e., its effective loading resistance R_{L}. Herein, the value of L₀′ (corresponding to L₀ of the prior art) is set to optimal, and not provided with an arbitrary value used in further calculations, as in the prior art. Also, the tuning capacitor values differ from those of the prior art (C_{T} herein corresponding to C₁ and C_{1P}+C_{SW1} to C₀ of the prior art).

Third, in the present solution according to FIG. 3 and FIG. 4, the quality factor of the antenna circuit can be simply scaled separately for the NFC communication mode and power transmission mode. In the power transmission mode, it is preferable to use a higher quality factor for the antenna circuit than in the NFC communication mode for minimizing power losses. In the NFC communication mode, the quality factor is restricted by the rise and fall time requirements of the envelope of the modulated signal. In the solution described above, there is a parallel resistance R_{P} (or alternatively a series resistance) connected to the antenna tuning network by SW1 and scaling down the quality factor in the NFC communication mode, whereby the quality factor of the power transmission mode is not affected by it.

1. A combined near field communication and wireless power transmitter device, comprising:
a first antenna connected to an antenna tuning network and capable of coupling wirelessly to one or more second antennae in the near field of the first antenna with coupling characteristics,
means for communicating wirelessly using said first antenna with a near field communication device in a near field communication mode, and
means for transmitting wirelessly power using said first antenna to another electronic device in the vicinity of the first antenna in a power transmission mode,
wherein, said power transmission mode, the antenna tuning network is configured to change its input impedance if there is a change in said coupling characteristics.

2. The device according to claim 1, wherein said coupling characteristics include at least the coupling coefficient between the first antenna and a second antenna in the near field of the first antenna.

3. The device according to claim 1, wherein said coupling characteristics include at least the loading state of a second antenna in the near field of the first antenna.

4. The device according to claim 2, further comprising being a wireless charger device and said power transmission mode is a wireless charging mode for transmitting charging power to a mobile battery-operated device via said first and second antennae.

5. The device according to claim 1, wherein the input impedance of the antenna tuning network is adapted to:
decrease if the coupling coefficient between the first and second antenna increase, and
increase if the coupling coefficient between the first and the second antenna decrease.

6. The device according to claim 1, wherein the input impedance of the antenna tuning network is adapted to:
decrease if the effective load resistance of the second antenna is decreased, and
increase if the effective load resistance of the second antenna is increased.

7. The device according to claim 1, wherein the antenna tuning network is adapted to keep the first antenna in resonance with the second antenna regardless of the coupling coefficient between the first and second antennae and the effective load resistance of the second antenna.

8. The device according to claim 1, further comprising means for switching between a NFC communication mode utilizing said means for communicating wirelessly with a near field communication device and a power transmission mode utilizing said means for transmitting power wirelessly to the another electronic device.

9. The device according to claim 1, further comprising means for operating said means for communicating wirelessly with a near field communication device and said means for transmitting power wirelessly simultaneously in a combined NFC communication and power transmission mode.

10. The device according to claim 1, wherein said means for communicating wirelessly with a near field communication device comprise an NFC RF generator and NFC tuning network for NFC operation of the device, and said means for transmitting power comprise a power RF generator separate from the NFC RF generator for power transmission mode operation of the device, and the device comprises a switch for decoupling the power RF generator from the NFC RF generator.

11. The device according to claim 10, wherein said switch, when in open state, decouples the antenna tuning network from the NFC tuning network such that the quality factor of the device in the power transmission mode is higher from the quality factor of the device in the NFC communication mode.

12. The device according to claim 1, wherein:
said means for communicating wirelessly with a near field communication device comprise a NFC RF generator and NFC tuning network connected to the first antenna via a connection point,
said means for transmitting power wirelessly to the mobile device comprises a power RF generator connected to the first antenna via said connection point, and
said connection point exhibits a series inductance (L₀′)towards the power RF generator, a series capacitance (C_{T}) towards the first antenna and a parallel capacitance (C_{1P}) towards ground.

13. The device according to claim 1, further comprising a single RF generator providing power for both the NFC communication mode and the power transmission mode.

14. The device according to claim 1, wherein the antenna tuning network comprises only passive electrical components with predefined characteristic values for achieving said change of input impedance.

15. A method of transmitting power to an electronic device with a transmitter device capable of near field communication in an NFC communication mode and wireless power transmission in a power transmission mode through a single first antenna coupled to an antenna tuning network having an input impedance, said method comprising:
using said transmitter device in an NFC communication mode,
switching the transmitter device to a power transmission mode for transmitting power to the electronic device having a second antenna coupled with the first antenna with coupling characteristics and tuned into resonance with the first antenna, and
varying the input impedance of the antenna tuning network of the transmitter device if the coupling characteristics of the first and second antenna change during said power transmission.

16. The method according to claim 15, wherein the first antenna is adapted to operate in resonance and kept in resonance regardless of the change in the coupling characteristics.

17. The method according to claim 15, wherein the input impedance of the antenna tuning network is varied using only passive electronics.

18. The method according to claim 15, further comprising switching off the NFC communication mode in the transmitter device when switching to the power transmission mode.

19. The method according to claim 15, further comprising operating the transmitter device in a combined NFC communication mode and power transmission mode.

20. The method according to claim 15, wherein said electronic device is a mobile battery-operated device and said power transmitted is used to charge the battery of the mobile battery operated device.

21. The method according to claim 15, wherein said electronic device is an NFC transponder and said power transmitted is used to activate the transponder.
